(19) United States
(12) Patent Application Publication
(10) Pub. No.: US 2005/0057831 A1
(43) Pub. Date: Mar. 17, 2005

(54) Directional heat exchanger

(75) Inventor: Robert A. Marshall, Georgetown, TX (US)

Correspondence Address: BAKER BOTTS L.L.P., 2001 ROSS AVENUE, SUITE 600, DALLAS, TX, 75201-2980, US

(73) Assignee: Practical Technology, Inc.

(21) Appl. No.: 10/937,831

(22) Filed: Sep. 8, 2004

Related U.S. Application Data
(60) Provisional application No. 60/502,481, filed on Sep. 12, 2003.

(51) Int. Cl. H01S 3/14; G02B 5/22

(52) U.S. Cl. 359/885

(57) ABSTRACT

A directional heat exchanger system and method are provided. In one embodiment, the system includes a photonic band gap radiative emitter operable to be thermally coupled to a thermal energy source and accept thermal energy from the thermal energy source. The photonic band gap radiative emitter emits electromagnetic radiation which is incident on a surface of a load absorber.

### RELATED APPLICATIONS

This application claims the priority benefit of U.S. Provisional Application Ser. No. 60/502,481, entitled “Directional Heat Flow Regulator,” filed Sep. 12, 2003.

### TECHNICAL FIELD OF THE INVENTION

This invention relates generally to the field of thermal management and heat recovery and, more specifically to a directional heat exchanger.

### BACKGROUND OF THE INVENTION

Many traditional heat transfer and temperature regulation devices are limited by the second law of thermodynamics. The second law of thermodynamics may be stated in numerous ways. Conceptually simplified, the second law of thermodynamics states that heat generally flows from relatively hotter objects to relatively colder objects. This is the case for thermal transfer in a closed system by conduction or convection. Radiative heat transfer between equal surface area black or gray bodies, without any conductive or convective heat transfer, will also result in a net heat flow from the relatively hotter object to the relatively colder object. An evaporative heat pump may move heat from a hotter object to a colder object, limited by Carnot efficiency. Gray body power per unit area emitted by each body is equal to the Stefan-Boltzman constant, times temperature raised to the fourth power, times the material's emissivity coefficient. Gray body power per unit area absorbed by each body is equal to the Stefan-Boltzman constant, times temperature raised to the fourth power, times the material's absorption coefficient. For a gray body, the emissivity coefficient and the absorption coefficient are the same and equal to one minus the reflection coefficient. Materials with different emissivity and absorption coefficients can be selected to change the rate of heat flow. Some materials do not behave as gray bodies, possessing different emission and absorption coefficients.

Certain photonic crystals may be thermally stimulated to emit photons. Inverse opal and woodpile structures fabricated from Tungsten exhibit this quality. The spectral power density of spontaneously emitted photons from thermal stimulation may exceed that of a blackbody emitter.

Photonic crystals may also possess a photonic band gap. Possessing a photonic band gap means that for a certain range of wavelengths, no quantum mechanical states exist in the material for photons to occupy. Photons with these wavelengths are thus forbidden in the material and cannot propagate. These materials may have a complete stop band across a portion of the electromagnetic spectrum where no optical energy may be emitted or absorbed.

### SUMMARY OF THE INVENTION

In accordance with the present invention, a directional heat exchanger is provided that addresses disadvantages and problems associated with current systems and methods. Specifically, the present invention permits heat transfer from a relatively cooler object to a relatively hotter object by thermally stimulating a photonic band gap structure and allowing the resulting photon emissions to be absorbed by a material with a high absorption coefficient and a relatively lower emissivity coefficient. No external energy is required for heat movement. New, previously unattainable applications exist in: waste heat recovery, such as cooling tower replacement, electric power generation, chemical or industrial processes, metal smelting, ceramics, and refrigeration.

In accordance with the present invention, a directional heat exchanger system and method are provided. In one embodiment, the system includes a photonic band gap radiative emitter operable to be thermally coupled to a thermal energy source and accept thermal energy from the thermal energy source. The photonic band gap radiative emitter emits electromagnetic radiation which is incident on a surface of an absorber. In a particular embodiment, a vacuum canister may be disposed around the photonic band gap radiative emitter and the absorber to reduce the thermal conductivity between the photonic band gap radiative emitter and the absorber. In another particular embodiment, a filter may be interposed between the photonic band gap radiative emitter and the absorber to change the wavelength of the electromagnetic radiation emitted from the photonic band gap radiative emitter. In a further alternative embodiment, a light limiting device may be interposed between the photonic band gap radiative emitter and the absorber to restrict the amount of electromagnetic radiation emitted by the photonic band gap radiative emitter which is incident on the surface of the absorber.

In accordance with another embodiment of the present invention, a method of thermal energy transfer includes coupling a photonic band gap radiative emitter to an absorber. The first photonic band gap radiative emitter may be operable to accept thermal energy from a thermal energy source and emit electromagnetic radiation. The electromagnetic radiation emitted from the first photonic band gap radiative emitter may be incident on a surface of the first absorber. In a particular embodiment, the method also includes coupling a thermal energy source to the photonic band gap radiative emitter, and at least a portion of the electromagnetic radiation emitted from the first photonic band gap radiative emitter is absorbed by the first absorber. In another particular embodiment, the photonic band gap radiative emitter includes at least first and second photonic band gap radiative emitters and the absorber includes at least first and second absorbers, and the method further includes arranging the first and second photonic band gap radiative emitters and the first and second absorbers thermally in a series and/or parallel combination.

In accordance with a further alternative embodiment of the present invention, a directional heat exchanger may include a thermal energy source coupled to a plurality of photonic band gap radiative emitters operable to accept thermal energy from the thermal energy source and emit electromagnetic radiation. A plurality of load absorbers may be coupled to the plurality of photonic band gap radiative emitters such that electromagnetic radiation emitted from the plurality of photonic band gap radiative emitters is incident on surfaces of the plurality of load absorbers. The range of wavelengths of the electromagnetic radiation may overlap a range of wavelengths which the plurality of load absorbers absorb. A thermal energy acceptor operable to accept thermal energy from the plurality of load absorbers may be thermally coupled to the plurality of load absorbers. The plurality of photonic band gap radiative emitters and the plurality of load absorbers may be disposed within a vacuum canister operable to reduce the thermal conductivity between the plurality of photonic band gap radiative emitters and the plurality of load absorbers.

Technical advantages of particular embodiments of the present invention include a directional heat exchanger capable of operating as a thermal energy diode, a temperature gain device, a constant heat flow rate regulator, a constant temperature regulator, or a heat pipe, without the need for additional energy. Further, the directional heat exchanger may simultaneously operate in more than one mode.

Another technical advantage of particular embodiments of the present invention is a directional heat exchanger minimizing conductive and convective thermal energy transfer by placing the photonic band gap radiative emitter and the load absorber in a vacuum chamber, and/or placing the photonic band gap radiative emitter and load absorber in close proximity and selecting remaining gas molecules with a high Knusden number.

A further technical advantage of particular embodiments of the present invention is a photonic band gap radiative emitter which radiates power in a narrow spectral band to be absorbed at the load absorber. The spectral exitance per unit area of the photonic band gap material exceeds the level predicted by Stefan-Boltzman's law for a black body over a band of peak emission.

Yet another technical advantage of particular embodiments of the present invention is a shuttered or irised mirror interposed between the photonic band gap radiative emitter and the load absorber to selectively control the amount of radiation incident on the load absorber.

Other technical advantages are readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the invention, and for further features and advantages, reference is now made to the following description, taken in conjunction with the accompanying drawings, in which:

FIG. 1 illustrates a directional heat exchanger;

FIG. 2 illustrates an alternative embodiment of a directional heat exchanger;

FIG. 3 illustrates spectra of power flows in a directional heat exchanger in accordance with the present invention;

FIG. 4 is an example power transfer plot of a directional heat exchanger in accordance with the present invention;

FIG. 5 is an example directivity plot of a directional heat exchanger in accordance with the present invention;

FIG. 6 is a diagram of one embodiment of a stacked directional heat exchanger in accordance with the present invention; and

FIG. 7 illustrates one method of directional thermal regulation in accordance with the present invention.

### DETAILED DESCRIPTION OF THE INVENTION

The present invention relates to a directional heat exchanger which may be used as a thermal energy diode, a temperature gain device, a constant heat flow rate regulator, a constant temperature regulator, and/or a heat pipe. The directional heat exchanger may simultaneously operate in more than one mode.

The directional heat exchanger consists of a thermally stimulated source optical emitter radiatively coupled to a load absorber. The source and load absorbers are selected such that radiated energy couples strongly from the source emitter to the load absorber, but couples weakly from the load absorber to the source emitter. There is net energy flow from the source emitter to the load absorber, with little energy flow in the opposite direction. For the two emitters to be in equilibrium, a temperature gain is observed, with the load absorber being at a higher temperature than the source emitter. Sufficient energy is coupled to remove useful thermal energy from the system at a higher temperature than the input thermal energy.

Thermal power is applied to the system through a thermal energy source coupled to a photonic band gap radiative emitter. The photonic band gap radiative emitter radiates power in a narrow spectral band to be absorbed by a load absorber. The spectral exitance of the photonic band gap radiative emitter may exceed the level predicted by Stefan-Boltzman's law for a black body over a band of peak emission and the spectral exitance may be suppressed outside of the emission band. A small amount of the power may be reflected by the load absorber back to the photonic band gap radiative emitter, where it may be reabsorbed by the photonic band gap radiative emitter. The load absorber is a poor emitter. What power it does emit is predominately below the band gap of the photonic band gap radiative emitter, and is reflected back to the load absorber. Power is removed from the load absorber through a thermal energy acceptor, or heat sink, coupled to the load absorber. The system offers good heat flow directivity and makes it possible to have a net heat transfer from a relatively cool body to a relatively hot body. In this mode of operation the directional heat exchanger is acting as a thermal energy diode or a thermal check valve.

The directional heat exchanger can also be used for temperature gain operation. In this manner the directional heat exchanger may act as a heat pump or thermal charge pump. The thermal energy diode operation transports energy from the source emitter to the load absorber. If not all of the energy is removed from the system at the load absorber, the temperature of the load absorber will rise until the system regains equilibrium, where emitted energy, a function of temperature, equals incident energy minus reflected energy minus energy delivered to the load.

The directional heat exchanger can also be used as a constant heat flow regulator, which is closely related to the thermal energy diode operation. If the source emitter temperature is held constant, the heat flow into the system is constant over a range of output temperatures. The output temperature rises until enough heat flows out of the system to regain equilibrium.

When an iris is interposed between the photonic band gap radiative emitter and the load absorber, the directional heat exchanger can be used as a constant temperature regulator. A control system may maintain a constant heat flow by adjusting the iris, and thus the output temperature will be a constant.

The directional heat exchanger may also be used as a heat pipe. In this mode of operation the source emitter and load absorber may be separated by some distance and coupled with an optical waveguide such as a mirrored tube or a photonic band gap fiber.

In any of these modes of operation, heat flow may be controlled by a shuttered or irised mirror interposed between the source and load absorbers. Additionally, a filter may be interposed between the source and load absorbers to improve efficiency in any of these modes of operation. In alternative embodiments, the photonic band gap of the source emitter may be changed or eliminated. The dielectric constant and thus the gap frequency and gap width, may be changed by a variety of means, to include varying the gas pressure or composition. The band gap width is fundamentally related to the dielectric contrast between the solid and void regions of the photonic crystal. By varying the dielectric constant of the void region, such as by adding a gas of a different pressure or composition, the width of the band gap can be altered.

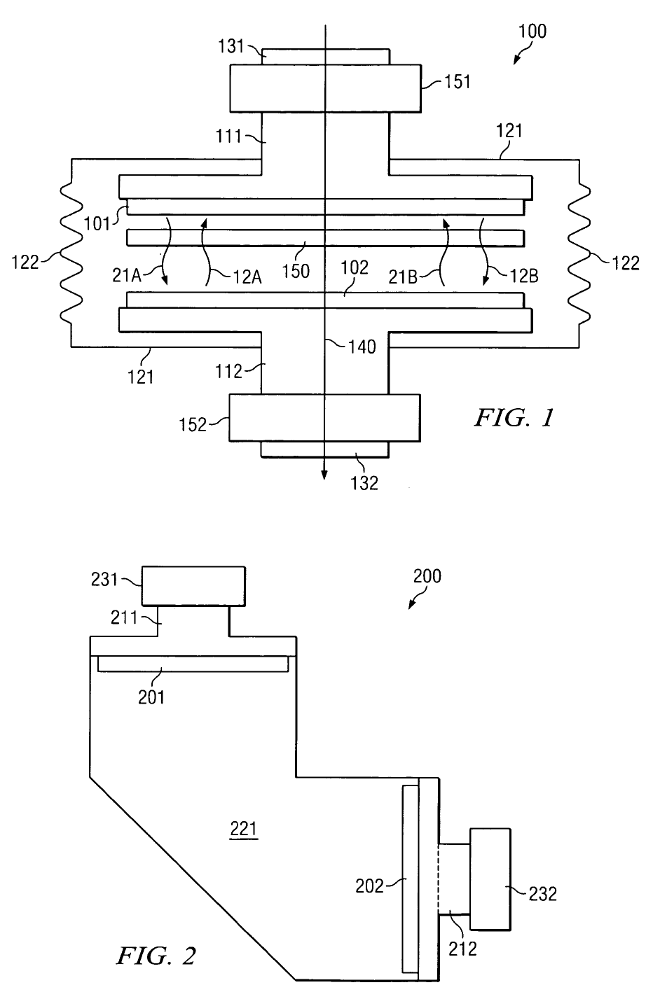

FIG. 1 is diagram illustrating a directional heat exchanger 100. Directional heat exchanger 100 may facilitate heat transfer from thermal energy source 131 to thermal energy acceptor 132. Thermal energy acceptor 132 may be at a higher or a lower temperature than thermal energy source 131. Thermal energy source 131 is coupled to a source emitter 101 by a source coupler 111. Source emitter 101 is constructed of a photonic band gap radiative material. Possessing a photonic band gap means that no quantum energy states exist within the energy band gap, thus transitions from an energy state above the gap energy to another energy state below the gap energy must be greater than the gap energy. Therefore, a photon generated by this transition must possess a wavelength less than the corresponding gap energy. Multiple states may exist both above and below the gap, resulting in polychromatic emissions. Photons with wavelengths corresponding to the energy gap in the quantum density of photon states are thus forbidden in the material and cannot propagate. These materials may have a complete stop band across a portion of the electromagnetic spectrum where no optical energy may be emitted or absorbed. Source emitter 101 also emits electromagnetic radiation under thermal stimulation. A photonic band gap radiative emitter, under thermal stimulation, is characterized by strong narrow band optical emissions at wavelengths above the photonic band gap, and excellent reflectivity within the photonic band gap. Reflectivity is a measure of the optical radiation which is incident on the surface of a material, but is not absorbed nor transmitted. Emitted power near the edge of the band gap may be in excess of Stefan-Boltzman's blackbody radiation law. The physics of this phenomenon are described in various scholarly scientific articles. Specifically, an example of one potential embodiment of source emitter 101 is described in “Three-Dimensional Photonic-Crystal Emitter for Thermal Photovoltaic Power Generation,” S. Y. Lin et al., Applied Physics Letters, Vol. 83, No. 2, p. 380-82. Another potential embodiment of source emitter 101 is described in “Tungsten Inverse Opals: The Influence of Absorption On the Photonic Band Structure in the Visible Spectral Region,” Georg von Freymann et al., Applied Physics Letters, Vol. 84, No. 2, p. 224-26. In further alternative embodiments, source emitter 101 may be any photonic crystal structure that will not melt or sublime at the operating temperature and pressure, and has sufficient gap width for the desired gain and directivity of heat flow regulator cell 100. All example quantities in the cited articles are for illustrative purposes only. The band gap energy can be readily shifted to be optimized for practically any desired operating temperature.

Radiatively coupled to source emitter 101 is load absorber 102. Load absorber 102 is a selective gray body emitter. In a particular embodiment, load absorber 102 could be dendritic nickel. Dendritic materials are well suited as load absorbers due to the surface characteristics of the dendrites. Microstructured materials, such as dendrites, have an unequal surface area between the microscopic level and the macroscopic area, making radiative energy absorption preferred over emission. In an alternative embodiment, load absorber 102 also possesses a photonic band gap, with a lower energy than source emitter 101. In alternative embodiments, load absorber 102 could be constructed of any material characterized by a relatively high absorption coefficient and a relatively lower emission coefficient.

In an alternative embodiment, source emitter 101 and/or load absorber 102 may be black body or other frequency selective emitters. A photonic directional coupler may be interposed between the two emitters. An example of such photonic directional couplers are described in “Nonlinear Photonic Crystal Microdevices for Optical Integration,” Marin Soljacic et al., Optics Letters, Vol. 28, No. 8, p. 637-639.

Both source emitter 101 and load absorber 102 continuously emit and absorb optical radiation. On average, source emitter 101 emits more energy than it absorbs, load absorber 102 absorbs more energy than it emits, and source emitter 101 emits significantly more energy than load absorber 102 at a given temperature. While generally true, not all of these generalities will hold true for every wavelength under every operating condition.

In the illustrated embodiment, source coupler 111 couples source emitter 101 to thermal energy source 131, and load coupler 112 couples load absorber 102 to thermal energy acceptor 132. Source coupler 111 and load coupler 112 are thermally conductive materials that transfer thermal power to source emitter 101 and from load absorber 102, respectively. Thermal energy source 131 and thermal energy acceptor 132 may be bulk metals, heat pipes, circulated liquid, or any other system(s) and/or method(s) for thermal energy transfer. The surfaces of source coupler 111 and load coupler 112 have low emissivity constants and may be further insulated to minimize losses to the ambient environment. In alternative embodiments, source emitter 101 could be directly coupled to thermal energy source 131 and load absorber 102 could be directly coupled to thermal energy acceptor 132.

Surrounding source emitter 101 and load absorber 102 is vacuum can 121. Vacuum can 121 reduces losses due to thermal conduction and convection through air. In a high vacuum, convective and conductive heat transfer are minimized due to an increase in mean free path of the gas molecules. In other words, on average, the gas molecules travel further between collisions and heat energy is not transferred by molecular interactions as quickly as it would be in a non-vacuum environment. Additional thermal conduction losses may be minimized by placing the source and load absorbers in close proximity, and by selecting remaining gas molecules with a high Knusden number. The Knusden number of a gas is a ratio of the gas's mean free path length to the characteristic length of the system. Alternatively, a high Knusden number gas may allow operation at higher gas pressures for the same thermal conductivity.

Vacuum can 121 may also have a reflective interior. A reflective interior may redirect stray radiation toward source emitter 101 or load absorber 102 and thereby reduce heat loss attributable to heating vacuum can 121 and the heat subsequently being lost to the environment. In the illustrated embodiment, vacuum can 121 also includes bellows 122. Bellows 122 may be constructed from flexible material which is a poor thermal conductor. In this manner bellows 122 may increase the conductive thermal resistance between source and load sides of the vacuum can. Bellows 122 may also reduce the stresses on the vacuum seals of vacuum can 121 by allowing for thermal expansion of various mechanical components.

In the illustrated embodiment, directional heat exchanger 100 includes thermal storage masses 151 and 152 coupled to source coupler 111 and load coupler 112, respectively. Thermal storage masses 151 and 152 may serve to reduce thermal shock due to any rapid change in input or output power flow. The size(s) of thermal storage masses 151 and 152 may be based on specific design requirements such as space limitations and the maximum anticipated thermal power surge or drop. Thermal storage masses 151 and 152 may be sufficiently sized to allow the maximum power transfer rate of source emitter 101 and load absorber 102 to be the average of a periodic load, using thermal storage masses 151 and 152 to store the peak load. This would allow smaller emitter areas to be used since source emitter 101 and load absorber 102 would no longer need to be capable of handling peak loads. Thermal storage masses 151 and 152 may be insulated by vacuum or any other insulation methods.

In the illustrated embodiment, a light limiting device 150 has been interposed between source emitter 101 and load absorber 102. Light limiting device 150 may be adjusted according to a desired power flow and closed during periods of no desired power flow. No power flow might be desirable when input power is low in order to, for instance, reduce parasitic losses. In one embodiment, light limiting device 150 may be a shutter. In an alternative embodiment, light limiting device 150 may be an iris. In a further alternative embodiment, light limiting device 150 may have an integral optical filter to enhance directivity. Source emitter 101 and load absorber 102 may radiate at different peak wavelengths. By interposing an optical filter between source emitter 101 and load absorber 102, the wavelength of peak transmission may be selected to correspond to the wavelength of peak emission from source emitter 101, and the wavelength of peak reflectance can be adjusted to correspond to the wavelength of peak emission of load absorber 102. In further alternative embodiments, a filter may be interposed between source emitter 101 and load absorber 102 without a light limiting device, or may be used in conjunction with a light limiting device without being integral to the light limiting device. Additionally, phosphors, dyes, or other spectral shaping may be applied to light limiting device 150.

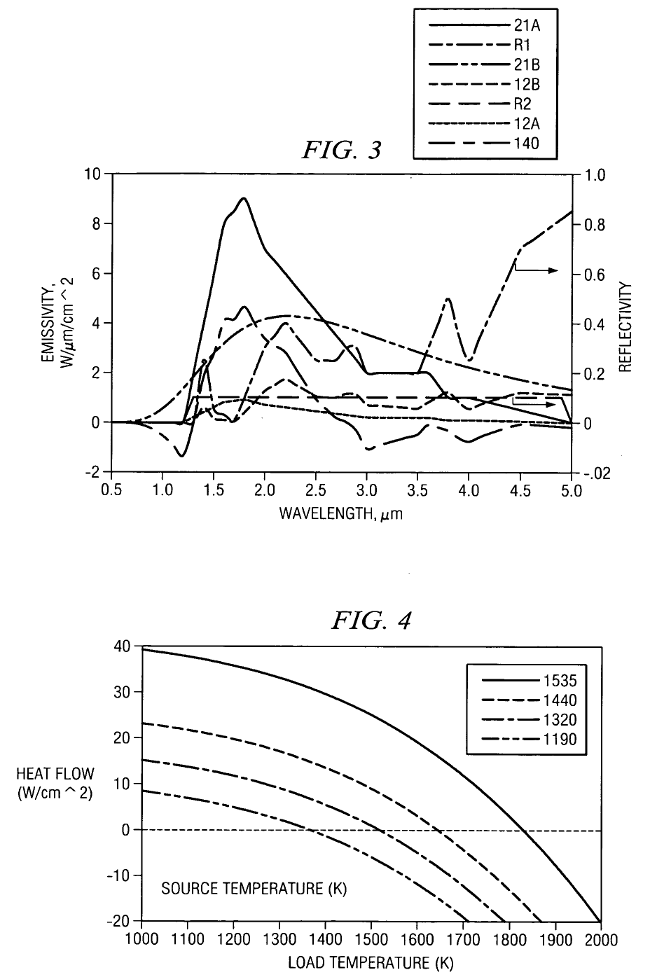

FIG. 1 illustrates a net forward power flow 140 through directional heat exchanger 100. Power flow 140 is from source emitter 101 to load absorber 102. Power flow 140 is a net power flow because it is a summation of power flows between the source emitter 101 and the load absorber 102. In particular embodiments, both source emitter 101 and load absorber 102 may be absorbing radiation and emitting radiation. This may be the case even if source emitter 101 has been chosen to minimize absorptivity and load absorber 102 has been chosen to minimize emissivity. These individual power flows are depicted in FIG. 1 as: source forward power 21A, load forward power 21B, source reverse power 12A, and load reverse power 12B. Further, both source emitter 101 and load absorber 102 may be reflecting a portion of the radiation incident on their surfaces. These power flows are illustrated in FIG. 3.

FIG. 2 illustrates an alternative embodiment of a directional heat exchanger 200. Thermal energy source 231 is coupled to a source coupler 211 which is coupled to the source emitter 201. In a like manner, load absorber 202 is coupled to load coupler 212 and thermal energy acceptor 232. Source emitter 201 and load absorber 202 may be placed a large distance apart and coupled with a reflective conduit 221, forming an optical heat pipe. Reflective conduit 221 may be a mirrored tube, or a photonic band gap fiber. Unlike conventional fluidic heat pipes, this heat pipe may be mounted upside down or in various configurations without loss of performance. As illustrated, reflective conduit 221 forms a ninety degree elbow between source emitter 201 and load absorber 202. Further, a stronger directivity to heat flow is observed, and heat can be pumped into a sink at a higher temperature than it entered the system.

FIG. 3 illustrates emissivity and reflectivity values for source emitter 101 and load absorber 102 across a range of wavelengths. An example emission spectra for a woodpile photonic band gap heated to 1190K is indicated as source forward power 21A. The reflectance of the load absorber material is shown as reflectance R2. Source reverse power 12A equals source forward power 21A, times reflectance R2. Net power delivered from the source to the load is source forward power 21A, minus source reverse power 12A. An example emission spectra of the absorber material at 1300K is indicated as load forward power 21B. The reflectance of the photonic band gap material is shown as reflectance R1. Load reverse power 12B equals load forward power 21B, times reflectance R1. Net power delivered from the load back to the source is load forward power 21B, minus load reverse power 12B. Net forward power flow 140 is net power delivered from the source to the load, minus net power delivered from the load back to the source. Although net power flow is negative, flowing from load to source, for some frequency bands, the average across the entire band is positive. It is seen that the photonic band gap has strong emissions in a narrow band and it is seen that photonic band gap has good reflectivity near the peak emission wavelengths of the load absorber. Alternate spectra are readily envisioned with different photonic band gap energies and alternate load absorber materials.

FIG. 4 is an example plot of power flow 140 versus temperature of load absorber 102 for various temperatures of source emitter 101 in accordance with the present invention. Power flow 140 flows from source emitter 101 to load absorber 102 until load absorber 102 is significantly hotter than source emitter 101. For a negative power flow 140, load absorber 102 must be externally heated. Otherwise, power flow 140 will limit to zero at the point of maximum temperature gain. Alternate operating temperatures, including room temperature, and power flow rates are readily envisioned. This example of temperature gain operation using the example materials and spectra from FIG. 3, modified for the plotted temperature, is for illustrative purposes only. Power flow is the integral of power across the entire spectrum for a given parameter. For source emitter 101 at 1190K, source forward power 21A is 11.8 W/cm², with dominant emissions from 1.5 to 1.9 μm. Load absorber 102, has a reflectance coefficient R2 of 0.1. This results in source reverse power 12A returning 1.2 W/cm² back to its source, source emitter 101. A power of 10.6 W/cm² is delivered to load absorber 102. If there is no thermal load on directional heat flow regulator 100, load forward power 21B minus load reverse power 12B minus net power flow 140 of zero, must equal 10.6 W/cm² to be in an equilibrium condition. This means the load absorber 102 is at a temperature of 1360K. The temperature of the load is hotter than the source. This is the maximum temperature gain, as load temperature divided by source temperature, of 1.14. No external energy is required to produce this temperature gain. Increasing net power flow 140 will reduce the temperature of load absorber 102, and more useful power will flow from a cold surface to a hot surface.

Power flow rate may be regulated by holding source emitter 101 at a constant temperature. This is valid over a range of temperatures of load absorber 102. Regulation is only slightly affected by the temperature of load absorber 102, as the photonic band gap emissions dominate the gray body emissions. Power flow rate may also be regulated by: varying the emission spectra of source emitter 101, varying the absorption and emission parameters of load absorber 102, and/or by using a filter and/or a light limiting device.

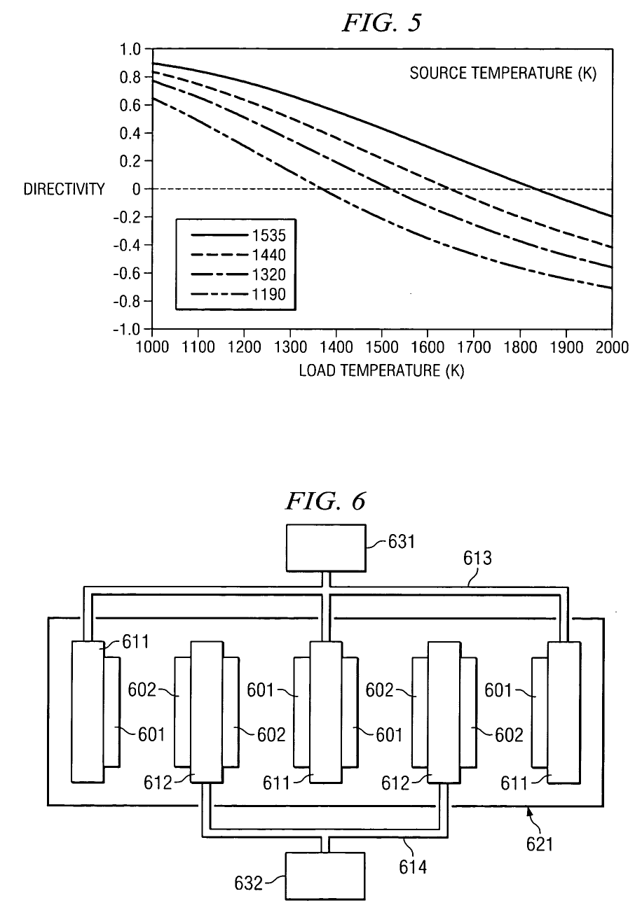

FIG. 5 is an example directivity plot of directional heat flow regulator 100 versus temperature of load absorber 102 for various temperatures of source emitter 101, in accordance with the present invention. Directivity, a figure of merit indicating how close the thermal diode is to breakdown, is defined as the ratio of net power flow 140 to total bi-directional emitted power, given as source forward power 21A plus source forward power 21B. For normal thermal conductors, the equivalent is the ratio of the integral of the momentum vectors of each moving atom to the sum of the magnitudes of the momentum vectors of each moving atom. Thus, for normal thermal conductors, the sign of directivity indicates which direction heat is flowing, which is always from a hotter source location to a cooler load location. Directivity of a pair of equal temperature black bodies, or metallic conductor, is zero, since energy is transferred equally well in both directions. This example is of thermal energy diode mode of operation, with temperature gain, using the example materials and spectra from FIG. 3, modified for the plotted temperature. This plot is for illustrative purposes only. Other operating values may have a temperature gain. For load absorber 102 temperature operation of 1190K, load absorber 102 emits a load forward power 21B at 11.8 W/cm², with a dominant emissions around 1.5 to 1.9 μm. Around this wavelength, load absorber 102, has a reflectance coefficient R2 of 0.1. This results in source reverse power 12A returning 1.2 W/cm² back to its source, source emitter 101. A power of 10.6 W/cm² is delivered to load absorber 102. For a load absorber 102 temperature of 1300K, net power flow 140, given as (source forward power 21A minus source reverse power 12A) minus (load forward power 21B minus load reverse power 12B), results in 2.2 W/cm² delivered as net power flow 140. Total bi-directional emitted power, as source forward power 21A plus load forward power 21B is 26.5 W/cm². Directivity, a figure of merit indicating how close the thermal diode is to breakdown, is the ratio of net power flow to total bi-directional power flow, is 0.11. If an external source is heating load absorber 102 above the maximum thermal gain of 1360K, the diode is in breakdown, with net energy now flowing opposite to net forward power flow 140, to the 1190K source emitter 101. Operating the thermal diode in breakdown will not damage the device unless the applied conditions are sufficiently extreme to melt the materials.

The temperature of load absorber 102 may be regulated by: varying the emission spectra of source emitter 101, leveling with thermal storage masses, varying the absorption and emission parameters of load absorber 102, and/or by using a filter and/or a light limiting device.

Lower operating temperatures, including room temperature, with lower band gap energies, are readily envisioned for applications in waste heat recovery from electric power generation; metallurgical, ceramic, and chemical processing; and/or refrigeration.

FIG. 6 is a diagram of one embodiment of a stacked directional heat exchanger in accordance with the present invention. Multiple source emitters 601 and load absorbers 602 are placed in an alternating polarity stack, thermally in parallel, for a higher heat flow rate. Stacking results in lower parasitic losses and better volume utilization of vacuum can 621. Source coupler 611 and load coupler 612 may be fluid filled heat sinks coupled to the thermal energy source 631 and thermal energy acceptor 632 by source plumbing 613 and load plumbing 614, respectively. In alternate embodiments, source plumbing 613 and load plumbing 614 may include practically any thermal transfer system(s) and/or method(s). In alternative embodiments, thermal storage masses may provide temperature leveling through batch cycling or other periodic variations. In a further alternative embodiment, multiple directional heat exchangers may be placed in series, resulting in a higher temperature gain or a higher directivity. Other series and/or parallel configurations of multiple directional heat exchangers are readily envisioned by one of ordinary skill in the art.

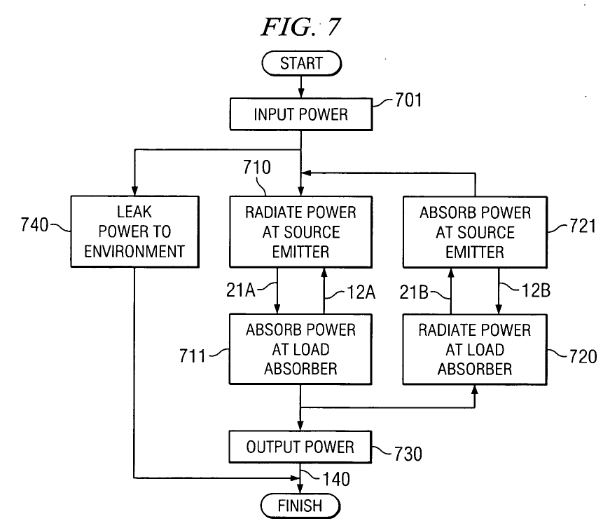

FIG. 7 is a flowchart demonstrating one method of directional thermal regulation in accordance with the present invention. Thermal power is input to the system at step 701. Thermal power is radiated as optical power at the source emitter at step 710. Source forward power 21A radiated at step 710 is absorbed at the load absorber at step 711, minus reflection losses, as source reverse power 12A. Thermal power is re-radiated at the load absorber at step 720. Power radiated at step 720 is absorbed by the source emitter at step 721, as load forward power 21B, minus reflection losses, as load reverse power 12B. The source and load absorber optical properties are selected such that there is relatively significant net power flow from the source emitter to the load absorber, or the load absorber is significantly hotter than the source emitter. In other words, the power radiated at step 710 is greater than the power radiated at step 720. Thermal power is removed from the system in step 730 as net power flow 140. Additionally, some power is lost to the environment as illustrated at step 740.

In a particular embodiment, a system for directional thermal energy transfer may include a photonic band gap source emitter radiatively coupled to a load absorber such that energy emitted from the source emitter is predominately absorbed by the load absorber. In one embodiment, the emission spectra of the source emitter may be approximately matched to the absorption spectra of the load absorber. In certain embodiments, the source emitter may be a three dimensional tungsten inverse opal photonic lattice. In certain embodiments, the load absorber may have a higher optical absorption coefficient than its optical emission coefficient. In certain embodiments, the load absorber may be a microstructured material such as dendritic nickel. In certain embodiments, the load absorber may have a photonic band gap of lower energy than the source emitter photonic band gap. In certain embodiments, a filter may be interposed between the source and load absorbers. In certain embodiments, an iris may be interposed between source and load absorbers to limit energy flow. In certain embodiments, at least one emitter may be coupled to a thermal storage mass. In certain embodiments, conductive and convective energy transfer between source and load absorbers may be minimized by using a vacuum canister. In certain embodiments, the walls of the vacuum canister may be reflective. In certain embodiments, the source and load sides of the vacuum canister may be coupled with a bellows. In certain embodiments, conductive energy transfer between the source emitter and load absorber may be minimized by having the source emitter and load absorber in close proximity. In certain embodiments, energy may be coupled into or out of the system with a thermal transfer fluid, through a thermally conductive mass, and/or by radiative means. In certain embodiments, the source emitters and load absorbers may be similarly sized parallel plates. In certain embodiments, alternating pairs of source emitters and load absorbers may be closely stacked in various series and/or parallel combinations.

In another particular embodiment, a system for directional thermal energy transfer could act as a thermal diode. The directivity could be greater than 0.05 at 500K input and 525K output. The directivity could also be greater than 0.1 at a 1200K input and 1300K output.

In another particular embodiment, a system for directional thermal energy transfer could act as a temperature gain block. The temperature gain could be greater than 1.15 at a 1500K input temperature under no load. Input temperature of less than 300K could have a temperature gain greater than 1.01 under no load.

A system for directional thermal energy transfer could act as a heat flow rate regulator, a temperature regulator, and/or a heat pipe.

In another particular embodiment, a method for directional thermal energy transfer may include a thermal energy source coupled to a thermally stimulated optical source emitter. The optical source emitter may be radiatively coupled to a load absorber. The load absorber may be coupled to a thermal energy load. At least one emitter may have a partial photonic band gap. The net energy flow may be from source to load and conductive and convective energy transfer may be minimized. In certain embodiments, the source emitter may have a complete three dimensional photonic band gap. In certain embodiments, the photonic band gap material may have an inverse opal structure. In certain embodiments, the source emitter may be a refractory metal. In certain embodiments, the source emitter may include a dye or phosphor. In certain embodiments, the load absorber emission coefficient may be lower than the absorption coefficient over the band of peak emission of the source emitter due to dendritic surface features. In certain embodiments, the load absorber may have a partial photonic band gap. In certain embodiments, the directional energy flow may be maintained over a wide temperature delta between the source and load absorbers, with a temperature gain. In certain embodiments, heat flow rate and temperature may be regulated. In certain embodiments, conductive and convective losses may be minimized by using a vacuum can. In certain embodiments, conductive losses within the vacuum can may be minimized with a serpentine structure. In certain embodiments, the source and load absorbers may be parallel plates with similar surface area. In certain embodiments, a multitude of said source and load absorber pairs may be alternately stacked, with interposed hot and cold heat transfer means. In certain embodiments, the conductive losses between source emitter and load absorber may be minimized by closely spacing the source emitter and load absorber. In certain embodiments, a multitude of source emitter and load absorber pairs may be stacked in series and/or parallel combinations. In certain embodiments, the source emitter and load absorber may be separated by a large distance and coupled with a conduit to form an optical heat pipe. In certain embodiments, the optical heat pipe may be coupled with a photonic band gap fiber.

In an alternative embodiment, a means for thermal energy transfer may include a thermally stimulated photonic band gap radiation emitter and an optically heated radiation absorber. Energy may be predominately transferred from a cooler body to a hotter body, and energy may flow predominately in one direction over a wide range of temperature. In certain embodiments, the energy flow and/or temperature may be regulated. In certain embodiments, energy may be transferred over a distance with minimal loss. In certain embodiments, the photonic crystal may have an inverse opal structure. In certain embodiments, a filter may be interposed between the emitter and absorber. In certain embodiments, the photonic crystal may not have a full three dimensional photonic band gap. In certain embodiments, the radiation absorber may have an absorption coefficient substantially higher than the reflection coefficient.

Although embodiments of the system and method of the present invention have been illustrated in the accompanying drawings and described in the foregoing detailed description, it will be understood that the invention is not limited to the embodiment disclosed, but is capable of numerous rearrangements, modifications, and substitutions without departing from the spirit of the invention as set forth and defined by the following claims.

1. A directional heat exchanger, comprising:
a photonic band gap radiative emitter operable to be thermally coupled to a thermal energy source;
the photonic band gap radiative emitter being further operable to accept thermal energy from the thermal energy source and emit electromagnetic radiation; and
wherein electromagnetic radiation emitted from the photonic band gap radiative emitter is incident on a surface of a load absorber.

2. The directional heat exchanger of claim 1, further comprising the thermal energy source and the load absorber, and wherein at least a portion of the electromagnetic radiation emitted from the photonic band gap radiative emitter is absorbed by the load absorber.

3. The directional heat exchanger of claim 1, further comprising:
a vacuum canister disposed around the photonic band gap radiative emitter and the load absorber; and
the vacuum canister being operable to reduce the number of particles surrounding the photonic band gap radiative emitter and the load absorber.

4. The directional heat exchanger of claim 3, further comprising bellows integral to the vacuum canister being operable to expand and thereby reduce mechanical stresses on the vacuum canister.

5. The directional heat exchanger of claim 3, further comprising reflective walls integral to the vacuum canister being operable to redirect the electromagnetic radiation.

6. The directional heat exchanger of claim 1, wherein an emission spectra of the photonic band gap radiative emitter is substantially matched to an absorption spectra of the load absorber.

7. The directional heat exchanger of claim 1, wherein the photonic band gap radiative emitter is a three-dimensional tungsten inverse opal photonic lattice.

8. The directional heat exchanger of claim 1, wherein an absorption coefficient of the load absorber is greater than an emission coefficient of the load absorber.

9. The directional heat exchanger of claim 1, wherein the load absorber is a microstructured material.

10. The directional heat exchanger of claim 1, wherein the load absorber is dendritic nickel.

11. The directional heat exchanger of claim 1, wherein the load absorber has a photonic band gap and the photonic band gap of the load absorber occurs at a lower energy than a photonic band gap of the photonic band gap radiative emitter.

12. The directional heat exchanger of claim 1, further comprising:
a filter interposed between the photonic band gap radiative emitter and the load absorber; and
the filter being operable to change the spectra of the electromagnetic radiation incident on the surface of the load absorber.

13. The directional heat exchanger of claim 1, further comprising: a light limiting device interposed between the photonic band gap radiative emitter and the load absorber; and
the light limiting device being operable to restrict the amount of electromagnetic radiation emitted by the photonic band gap radiative emitter which is incident on the surface of the load absorber.

14. The directional heat exchanger of claim 1, wherein the photonic band gap radiative emitter and the load absorber are similarly sized parallel plates.

15. The directional heat exchanger of claim 1, wherein:
the photonic band gap radiative emitter includes at least first and second photonic band gap radiative emitters; and
the load absorber includes at least first and second load absorbers.

16. The directional heat exchanger of claim 15, wherein the first and second photonic band gap radiative emitters and the first and second load absorbers are arranged thermally in parallel.

17. A method of thermal energy transfer, comprising:
coupling a photonic band gap radiative emitter to a load absorber;
the photonic band gap radiative emitter being operable to accept thermal energy from a thermal energy source and emit electromagnetic radiation; and
wherein electromagnetic radiation emitted from the photonic band gap radiative emitter is incident on a surface of the load absorber.

18. The method of claim 17, further comprising coupling a thermal energy source to the photonic band gap radiative emitter, and wherein at least a portion of the electromagnetic radiation emitted from the photonic band gap radiative emitter is absorbed by the load absorber.

19. The method of claim 17, further comprising:
disposing the photonic band gap radiative emitter and the load absorber within a vacuum canister; and
the vacuum canister being operable to reduce the number of particles surrounding the photonic band gap radiative emitter and the load absorber.

20. The method of claim 19, wherein the vacuum canister includes bellows operable to expand and thereby reduce mechanical stresses on the vacuum canister.

21. The method of claim 19, wherein the vacuum canister includes reflective walls operable to redirect the electromagnetic radiation.

22. The method of claim 17, further comprising matching an emission spectra of the photonic band gap radiative emitter to an absorption spectra of the load absorber.

23. The method of claim 17, wherein the photonic band gap radiative emitter is a three-dimensional tungsten inverse opal photonic lattice.

24. The method of claim 17, wherein an absorption coefficient of the load absorber is greater than an emission coefficient of the load absorber.

25. The method of claim 17, wherein the load absorber is a microstructured material.

26. The method of claim 17, wherein the load absorber is dendritic nickel.

27. The method of claim 17, wherein the load absorber has a photonic band gap and the photonic band gap of the load absorber occurs at a lower energy than a photonic band gap of the photonic band gap radiative emitter.

28. The method of claim 17, further comprising:
interposing a filter between the photonic band gap radiative emitter and the load absorber; and
the filter being operable to change a wavelength of the electromagnetic radiation incident on the surface of the load absorber.

29. The method of claim 17, further comprising:
interposing an iris between the photonic band gap radiative emitter and the load absorber; and
the iris being operable to restrict the amount of electromagnetic radiation emitted by the photonic band gap radiative emitter which is incident on the surface of the load absorber.

30. The method of claim 17, wherein the photonic band gap radiative emitter and the load absorber are similarly sized parallel plates.

31. The directional heat exchanger of claim 17, wherein:
the photonic band gap radiative emitter includes at least first and second photonic band gap radiative emitters; and
the load absorber includes at least first and second load absorbers.

32. The directional heat exchanger of claim 31, further comprising arranging the first and second photonic band gap radiative emitters and the first and second load absorbers thermally in parallel.

33. A directional heat exchanger, comprising:
a thermal energy source;
a plurality of photonic band gap radiative emitters thermally coupled to the thermal energy source;
the plurality of photonic band gap radiative emitters being operable to accept thermal energy from the thermal energy source and emit electromagnetic radiation;
a plurality of load absorbers coupled to the plurality of photonic band gap radiative emitters such that electromagnetic radiation emitted from the plurality of photonic band gap radiative emitters is incident on surfaces of the plurality of load absorbers;
wherein a range of wavelengths of the electromagnetic radiation overlap a range of wavelengths which the plurality of load absorbers absorb;
a thermal energy acceptor thermally coupled to the plurality of load absorbers;
the thermal energy acceptor being operable to accept thermal energy from the plurality of load absorbers;
wherein the plurality of photonic band gap radiative emitters and the plurality of load absorbers are disposed within a vacuum canister;
the vacuum canister being operable to reduce the number of particles surrounding the plurality of photonic band gap radiative emitters and the plurality of load absorbers; and
wherein a gas within the vacuum canister is characterized by a high Knusden number.
